(19) United States
(12) Patent Application Publication
(10) Pub. No.: US 2022/0387150 A1
(43) Pub. Date: Dec. 8, 2022

(54) REAL TIME BASE ADAPTATION

(71) Applicant: Global Dental Science, LLC, Scottsdale, AZ (US)

(72) Inventor: Scott Keating, Louisville, CO (US)

(21) Appl. No.: 15/697,695

(22) Filed: Sep. 7, 2017

Related U.S. Application Data
(60) Provisional application No. 62/368,046, filed on Jul. 28, 2016.

(51) Int. Cl. A61C 13/34; G06F 17/50; A61C 13/00

(52) U.S. Cl. CPC A61C 13/34; G06F 17/50; A61C 13/0004

(57) ABSTRACT

The invention comprises an improved method and system for building a denture. The invention further comprises a technique for building teeth and a denture base in a digital space. The invention even further comprises a method for adapting a digital denture base contemporaneously with changes made to digital teeth on the same model.

### BACKGROUND OF THE INVENTION

The invention comprises an improved method and system for building a prosthetic device. The invention further comprises a technique for building teeth and a denture base in a digital space such as a denture design software. The invention even further comprises a method for adapting some or a complete digital denture base contemporaneously as changes are made to digital teeth on the same digital model.

### 1. Field of the Invention

The present invention relates to the field of manufacturing digital dentures. The present invention further relates to designing digital dentures for patients. The present invention even further relates to a system of modifying digital denture teeth while adapting the base of the denture through computer software.

### 2. Description of Related Art

The idea of designing teeth in virtual space is fairly common in prior art. For prosthetic solutions such as dentures and crown/bridge work, such solutions are well known in the prior art and are well commercialized. Teeth are designed and customized for each patient by using data derived from imaging the patient's anatomy, occlusion, existing prosthetics, etc. However, prosthetic bases must also be designed and modified to properly fit and support the new teeth of the patient.

Such prior art solutions take the approach of designing the teeth first to achieve proper occlusion and functionality along with optimal aesthetics. The base of the prosthetic is built after the teeth are set so that the designer of the prosthetic must manually sculpt the prosthetic base after making changes to the teeth. Most software programs used to facilitate prosthetic designs, in fact, depict the surface of teeth apart from the base, or floating in space, throughout in the design operation. Any revisions to the tooth position or other changes to the teeth-for example, due to additional information gleaned through try-ins or subsequent imaging, will require additional manual configurations of the denture base or complementary prosthetic component. In some prior art solutions, one must completely rebuild the denture base each time the tooth position is changed. Though some prior art solutions may allow auto-fill of the teeth at the intaglio surfaces or touch up work, largely the work of rebuilding bases is sculpted manually (ie, using a mouse or other input interface to change the boundary lines). This process is sometimes inconsistent and always inefficient. Base surfaces often appear as meshes or surfaces in common designing software. If the user simply moves the mesh or changes the dimensions of the base to meet the modifications of the tooth, the base structures stretch or retract without maintaining the characteristics of pockets, root eminences, gingiva, rugae minimum thickness and other anatomical landmarks that demark and mimic the functional and aesthetic characteristics of the natural anatomy of the patient.

There remains a solution for a method and system for improving the process of digitally correcting the base of a dental prosthetic to the changes made to artificial teeth designed in a computer software program. There further remains a solution for base adaptation tool disposed within prosthetic tooth design software that enables real-time adjustments upon the prosthetic base that correlate to the modifications to teeth being designed for functionality and aesthetic purposes. There even further remains a solution that eliminates the need to redo a prosthetic base for the same patient upon subsequent re-workings of the same prosthesis.

### SUMMARY OF THE INVENTION

These and other objects were met with the present invention. In a first embodiment, the present invention comprises a method for designing a prosthetic structure that includes a tooth portion and a base portion, the method comprising acquiring a set of data relating to the natural anatomy of a patient, building the prosthetic tooth portion in a computer software program using the set of data, the tooth structure having anatomical landmarks, pre-loading parameters for the dimensions of the base portion, adapting the base portion of the prosthetic structure to the modifications to the tooth portion contemporaneously, so that anatomical landmarks and shapes may be mimicked within the parameters for the dimensions of the base portion. The first embodiment may further comprise the set of data relevant to the natural anatomy of the patient being derived from imaging of a patient's oral anatomy, from the scanning of an impression of the patient's oral anatomy, or being selected from a closest match of a database of selected anatomical profiles; whereby the parameters of the base portion may include controlling portions of at least one of the following surfaces of the base portions from adapting: the intaglio surface, the borders of the base portion, buccal reflections, vestibule, so that the base portion retains a complementary relationship to the natural anatomy of the patient; whereby the base portion maintains a minimum thickness regardless of volumetric reductions of the tooth portion accomplished during the step of adapting the base portion of the prosthetic structure to the modifications to the tooth portion contemporaneously; whereby the base portion may be integrated with the tooth portion during the step of adapting the base portion of the prosthetic structure to the modifications to the tooth portion contemporaneously, so that anatomical landmarks and shapes are mimicked within the parameters for the dimensions of the base portion. The method in the first embodiment may further comprise the prosthetic structure further being a full arch denture, and a product manufactured by the method of the first embodiment.

In a second embodiment of the invention, a method for designing a prosthetic structure that includes a tooth portion and a base portion may comprise acquiring a set of data relating to a prosthetic device customized for the patient, building the prosthetic tooth portion in a computer software program using the set of data, the tooth structure having anatomical landmarks, pre-loading parameters for the dimensions of the base portion, adapting the base portion of the prosthetic structure to the modifications to the tooth portion contemporaneously, so that anatomical landmarks and shapes are mimicked within the parameters for the dimensions of the base portion; whereby the parameters of the base portion may include controlling portions of at least one of the following surfaces of the base portions from adapting: the intaglio surface, the borders of the base portion, buccal reflections, vestibule, so that the base portion retains a complementary relationship to the natural anatomy of the patient; whereby the base portion maintains a minimum thickness regardless of volumetric reductions of the tooth portion accomplished during the step of adapting the base portion of the prosthetic structure to the modifications to the tooth portion contemporaneously; whereby the base portion may be integrated with the tooth portion during the step of adapting the base portion of the prosthetic structure to the modifications to the tooth portion contemporaneously, so that anatomical landmarks and shapes are mimicked within the parameters for the dimensions of the base portion.

The second embodiment of the invention may further comprise the prosthetic structure further being a full arch denture, and may comprise a product manufactured by the method of the second embodiment; whereby the prosthetic device customized for the patient is a denture that has been scanned; whereby the prosthetic device customized for the patient is digital denture previously designed for the patient; whereby step of adapting the base portion of the prosthetic structure to the modifications to the tooth portion contemporaneously adapts the cameo surface and the volumetric effect of the base portion; whereby step of adapting the base portion of the prosthetic structure to the modifications to the tooth portion contemporaneously adapts the cameo surface and the volumetric effect of the base portion; whereby the step of adapting the base portion of the prosthetic structure to the modifications to the tooth portion contemporaneously includes reserving space for a strengthening material that may span at least a part of the base portion.

### BRIEF DESCRIPTION OF THE DRAWINGS

A more complete understanding of the present invention may be derived by referring to the detailed description and claims when considered in connection with the Figures, where like reference numbers refer to similar elements throughout the Figures:

FIG. 1a depict an inferior palatal view of a prosthetic denture with markers affixed upon gingival portions of a base complements the modification of an artificial tooth structure.

FIG. 1b depict the same view as in FIG. 1a but showing the gingival portions of the base being adapted to the changes indicated by the arrows moved by the affixed upon gingival portions of a base complements the modification of an artificial tooth structure

FIGS. 1c and 1d depict the same view as in FIG. 1a, but showing the base portion being adapted to changes in tooth position.

FIG. 2a depicts a side view of an upper denture showing an initial position of the lingual side of the upper denture.

FIG. 2b depicts the same view of an upper denture as in FIG. 3a, but showing the base portion of upper denture being adapted as the tooth angulation and shape is modified.

FIG. 3a a side view of an upper denture showing an initial position of the lingual side of the upper denture.

FIG. 3b depicts the same view of an upper denture as in FIG. 3a, but showing the base portion of upper denture being adapted for changes to the occlusal plane of the upper denture.

### DETAILED DESCRIPTION OF THE INVENTION

The present invention solves a number of issues with designing prosthetic teeth in the prior art. The present invention provides a digital adaptation of the base portion of a dental prosthetic structure during the process modifying the teeth portion. The present invention reduces the need to manually sculpt the base portions of the digital prosthetic after modifying the tooth or teeth portions. The present invention further solves the problem of having to manually re-sculpt the same digital base portion of a prosthetic upon subsequent modifications to the same dental prosthetic.

According to the Figures provided, a method and system of adapting the base portion to movements and modifications of the teeth are disclosed.

In an embodiment of the inventive process, a user who designs a dental prosthetic structure engages a digital software platform that utilizes patient information and data acquired through imaging, impressions and scans thereof, and other means known in the arts. In one embodiment of the invention, the user may engage in standalone computation that is unique to the patient information. In another embodiment, the user may select a template from a database of selected anatomical profiles, or of preferred dental prostheses that provide a setup and analogue to sculpt the customized prosthesis for the patient.

The user may begin sculpting or positioning the teeth, according to techniques and tools utilized in the software displayed in a computer interface. In a preferred embodiment of the invention, a base portion of the prosthetic structure is displayed in a direct or exploded view under the tooth portion of the prosthetic structure, for example on a display screen or other 3D interface to the user such as a hologram. As the user modifies the teeth in the designing operation of the software, the base portion of the prosthetic structure adapts to support the change. The user may implement a variety of changes, from subtle sculpting to major changes including remove a tooth or teeth, changing out molds, or other functional and aesthetic changes.

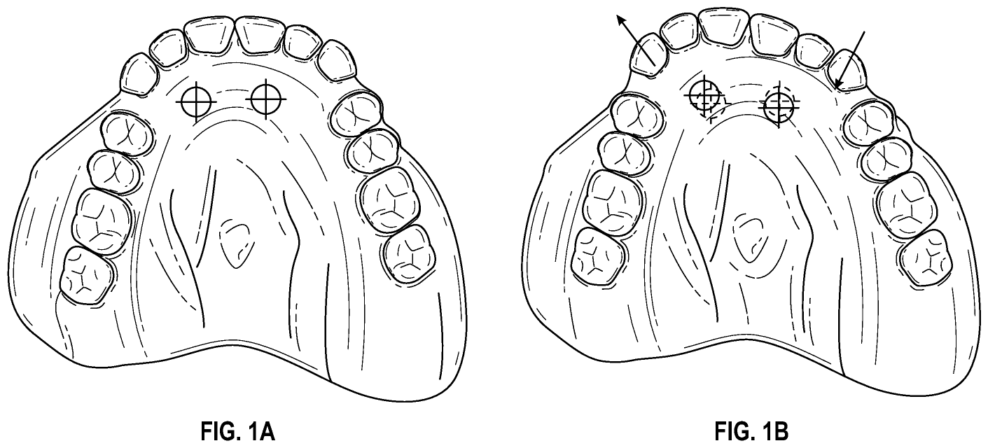

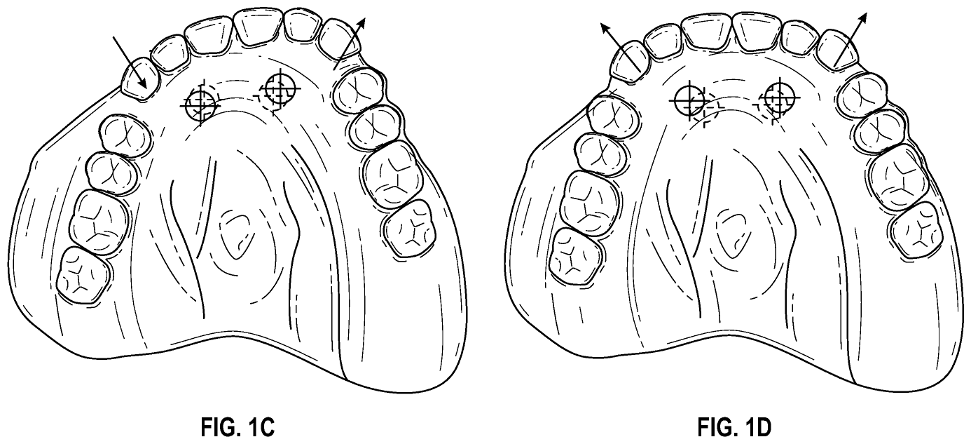

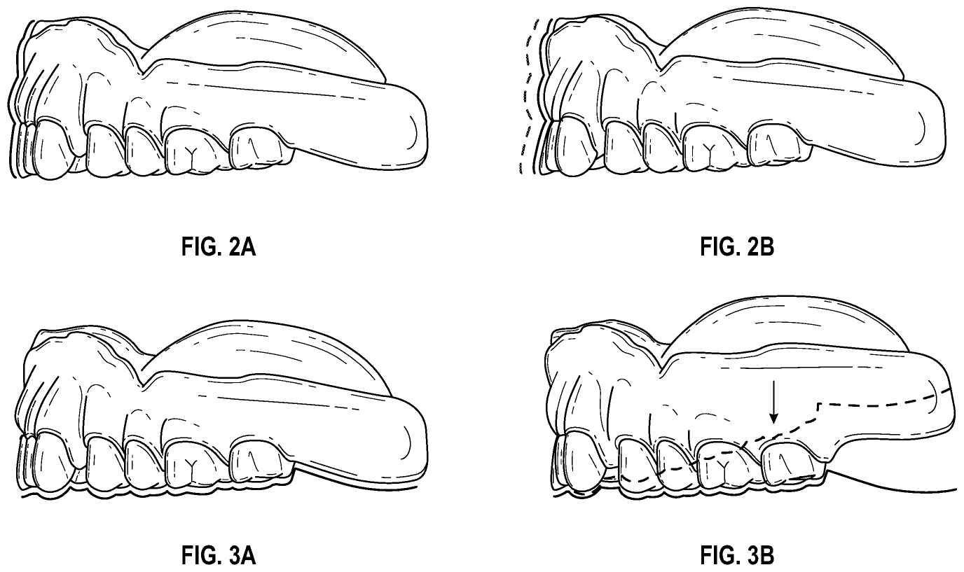

According to the embodiments illustrated in FIGS. 1-3, the base may react contemporaneously to match the changes of the tooth portion as design changes are made on the screen. Shown are changes to tooth position in the inferior palatal views in FIGS. 1a-d, to adjustments in tooth angulation and position in FIGS. 2a-2b, and to modifications to the occlusal plane of FIGS. 3a-3b that bring (for example) the upper arch denture into better occlusion with the lower denture (not shown) of the patient. The resulting changes to the base may be more pronounced along the arch proximal to the tooth portions, and less so to the more lingual aspects of the base portion of the upper denture. Specifically, FIG. 1a shows a first set of fiducial markers in an initial position. FIGS. 1b-d depict a second set of fiducial markers after the base adapts to the changes in tooth portion position, indicated by the solid line circles, with the first set of fiducial markers now shown in dotted line form. The adjustment in position of the second set of fiducial marks notates an exemplary base adaptation that is not linear or precise to the change in the tooth position. In other words, the change in the base portion may be driven by factors such as aesthetics, functionality, and other variables rather than simply the distance of tooth portion repositioning. FIGS. 2a and 2b show changes to the buccal side of the tooth portion and its complementary base portion adaptation, illustrating how tooth portion angulation and positioning may incur a base adaptation that is not necessarily a mirror change, but also accounts for changes in the roots of the tooth portion and other factors. FIGS. 3a and 3b illustrate how malocclusion adjustments may be adjusted in the base portion through pre-set parameters to the base portion, and that such adjustments may be more heavily applied to the arch portions proximal to the tooth than evenly distributed throughout the base portion.

In an embodiment of the invention, the described method comprises functional changes to the tooth portion that may include widening or narrowing an arch, moving an occlusal plane up or down, opening bite, closing the bite, correcting a cross-bite, changing tooth angles such as lingualization angle or cusp angles, lingualization of the posterior teeth, gross set-up changes (up-down-vertical), scaling the teeth, morphing the teeth (improving the cusps and/or fossae), stretching of the teeth.

In each of these functional and aesthetic changes of the teeth, the inventive process and system enables the adaptation of the base while changing the dimensions, position and shape of the teeth.

Once the modifications have been made to the tooth portion positions or to customize the patient teeth and the complementary base, additional aesthetic and/or functional changes to the teeth may be necessary, such as lowering the incisal edge, moving the incisal edge up, randomization to achieve a more natural appearance of the prosthetic structure, creating diastemata, and other aesthetic or functional changes.

The base portion may be attached to the teeth in the same relationship on the screen/interface and during the modification as it created and further manufactured (such as milled, 3D printed, or other manufacturing techniques known in the arts) out into the physical embodiment of the prosthetic, such as a denture. It may also be exploded out to a predetermined distance for the purposes of appreciating the relationship of the base portion to the tooth portion.

The base portion may be enabled with a number of preset variables to ensure that the strength, functionality and other desirable characteristics are not compromised by changes to the tooth portion. In one example, portions that fit against the patient's anatomy may be controlled so that they do not change. For instance, the inventive method may limit changes to the palate, especially on the intaglio surface. Changes to the border molding of a denture may also be limited on the intaglio surface. Adaptations of the vestibule anatomy and/or buccal reflection may be controlled so that those structures are not changed. In another embodiment, other aesthetic inputs to the base portion may be controlled, so that natural rugae of the patient is utilized rather than being stretched according to a standard base adaptation formulation.

In an embodiment of the invention, a controlled (e.g., minimum) thickness of the base portion is maintained regardless of the thickness of the artificial teeth structures.

In another embodiment of the invention, the base adaptation does not include changes on the borders and intaglio surface, but modifies or adapts the cameo surface and the volumetric effect.

In yet another embodiment where a denture is desired by a dental professional to include a bar or other strengthening material for the purpose of strengthening. The inventive method and system includes a bar or other strengthening material design template or tool for adapting the base to the teeth that automatically implements spacing for the bar. It may be desirable to achieve and maintain a cantilever effect with the bar design within the base adaptation.

These and other variables known in the arts of prosthetic structure design may be input into the base portion adaption tool so that as the base portion morphs to complement modifications to the tooth portion, the base portion does not exceed certain preset parameters that are selected and desirable for functional and aesthetic characteristics of the patient's prosthesis.

Other variations and specialized circumstances may be implemented with this inventive base adaptation.

While the present invention has been described in conjunction with the specific embodiments set forth above, many alternatives, modifications and other variations thereof will be apparent to those of ordinary skill in the art. All such alternatives, modifications and variations are intended to fall within the spirit and scope of the present invention.

1. A method for designing a denture that includes a tooth portion and a base portion, the method comprising:
acquiring a set of data relating to the natural anatomy of a patient;
building a tooth portion in a computer software program using the set of data, the tooth portion having anatomical landmarks;
pre-loading parameters for the dimensions of a base portion;
modifying the shape and position of the tooth portion, configured to improve functional and aesthetic customization of the denture for the patient, the step of modifying the shape and position of the tooth portion being selected from a group of at least one functional change: widening or narrowing an arch, moving an occlusal plane up or down, opening a bite, closing the bite, correcting a cross-bite, changing tooth angles such as a lingualization angle or a cusp angle, lingualization of a part of the tooth portion, a gross set-up change, scaling a part of the tooth portion, morphing a part of the tooth portion by improving the cusps or fossae of a tooth, stretching a part of the tooth portion;
adapting the base portion of the denture in real time in reaction to modifying the shape and position of the tooth portion on a display screen during the step of modifying the shape and position of the tooth portion, configured to improve functional and aesthetic customization of the denture for the patient;
controlling a thickness of the base portion during the step of adapting the base portion of the denture in real time on a display screen regardless of the thickness of the tooth portions.

2. The method of claim 1, the set of data relevant to the natural anatomy of the patient being derived from imaging of a patient's oral anatomy.

3. The method of claim 1, the set of data relevant to the natural anatomy of the patient being derived from the scanning of an impression of the patient's oral anatomy.

4. The method of claim 1, the set of data relevant to the natural anatomy of the patient being selected from a closest match of a database of selected anatomical profiles.

5. The method of claim 1, whereby the parameters of the base portion may include controlling portions of at least one of the following surfaces of the base portion from adapting: an intaglio surface, a border of the base portion, a buccal reflection, a vestibule, so that the base portion retains a complementary relationship to the natural anatomy of the patient.

6. (canceled)

7. The method of claim 1, whereby the base portion may be integrated with the tooth portion during the step of adapting the base portion of the denture in real time in reaction to modifying the tooth portion on a display screen during the step of modifying the shape and position of the tooth portion, configured to improve functional and aesthetic customization of the denture for the patient to support the modifications to the tooth portion contemporaneously, so that anatomical landmarks and shapes are mimicked within the parameters for the dimensions of the base portion.

8. The method of claim 1, the denture further comprising a full arch denture.

9. A product manufactured by the method of claim 1.

10. A method for designing a denture that includes a tooth portion and a base portion, the method comprising:
acquiring a set of data relating to a denture customized for the patient;
initializing the tooth portion in a computer software program using the set of data, the tooth portion having anatomical landmarks;
modifying the shape and position of the tooth portion, configured to improve functional and aesthetic customization of the denture for the patient, the step of modifying the shape and position of the tooth portion being selected from a group of at least one functional change: widening or narrowing an arch, moving an occlusal plane up or down, opening a bite, closing the bite, correcting a cross-bite, changing tooth angles such as a lingualization angle or a cusp angle, lingualization of a part of the tooth portion, a gross set-up change, scaling a part of the tooth portion, morphing a part of the tooth portion by improving the cusps or fossae of a tooth, stretching a part of the tooth portion;
pre-loading parameters for the dimensions of the base portion;
adapting the base portion of the denture in real time in reaction to modifying the shape and position of the tooth portion, configured to improve functional and aesthetic customization of the denture for the patient to support the modifications to the tooth portion;
controlling a thickness of the base portion regardless of the thickness of the tooth portion.

11. The method of claim 10, whereby the parameters of the base portion may include controlling portions of at least one of the following surfaces of the base portion from adapting: an intaglio surface, a border of the base portion, a buccal reflection, a vestibule, so that the base portion retains a complementary relationship to the natural anatomy of the patient.

12. (canceled)

13. The method of claim 10, whereby the base portion may be integrated with the tooth portion during the step of adapting the base portion of the denture in real time in reaction to modifying the shape and position of the tooth portion, configured to improve functional and aesthetic customization of the denture for the patient to support the modifications to the tooth portion contemporaneously, so that anatomical landmarks and shapes are mimicked within the parameters for the dimensions of the base portion.

14. The method of claim 10, the denture further comprising a full arch denture.

15. A product manufactured by the method of claim 10.

16. (canceled)

17. The method of claim 10, whereby the denture customized for the patient is a digital denture previously designed for the patient.

18. The method of claim 10, whereby step of adapting the base portion of the denture in real time in reaction to modifying the shape and position of the tooth portion, configured to improve functional and aesthetic customization of the denture for the patient to support the modifications to the tooth portion contemporaneously adapts a cameo surface and a volumetric effect of the base portion.

19. The method of claim 1, whereby step of adapting the base portion of the denture in real time in reaction to modifying the shape and position of the tooth portion, configured to improve functional and aesthetic customization of the denture for the patient to support the modifications to the tooth portion contemporaneously adapts a cameo surface and a volumetric effect of the base portion.

20. The method of claim 12, whereby the step of adapting the base portion of the denture in real time in reaction to modifying the shape and position of the tooth portion, configured to improve functional and aesthetic customization of the denture for the patient to support the modifications to the tooth portion contemporaneously includes reserving space for a strengthening material that may span at least a part of the base portion.
